(19) United States
(12) Patent Application Publication
(10) Pub. No.: US 2008/0156564 A1
(43) Pub. Date: Jul. 3, 2008

(54) Electric horse(tm): battery powered electric motor bicycle drive train

(76) Inventor: Kenneth Leroy Driessen, Hayward, WI (US)

Correspondence Address: Kenneth Leroy Driessen, 12022 N. Co. Rd. T, Hayward, WI, 54843, US

(21) Appl. No.: 11/647,104

(22) Filed: Dec. 29, 2006

(51) Int. Cl. B62K 11/00

(52) U.S. Cl. 180/220

(57) ABSTRACT

The Electric Horses a battery powered electric motor bicycle drive train that in its entirety is new to the art of electric two-wheel vehicle design. The following statements briefly explain interdependent claims of components, to which the claim of the entire unit depends upon. Adapting a drive mechanism to mount on bicycle industry standard hub hardware designed for caliper breaking machinery is claimed to be original. The bevel/pinion housing unit is claimed to be a new design. The shaft connecting the bevel/pinion gear set to the transmission is claimed to be original. The transmission(s) are claimed to be new to the art in gear ratio, size and design. The transmission shifting mechanism being controlled by a stepper motor is claimed original. The modifications to the motor controller are said to be original. The combination, controller, charger, battery pack, luggage rack is claimed to be original. The entire Electric Horse™ and the component assemblies (1) (a) thru () are claimed original and patent able.

### PREAMBLE

The Electric Horse™ a battery powered electric motor bicycle drive train. The trade name is registered in the State of Wisconsin and a copy of the registration is attached. The mounting of a bevel gear to the ISO and/or the Shimano break rotor-mounting pattern is an original concept. The mating of the pinion to the bevel and the housing thereof is also an original and functional design. The use of a drive shaft with a sliding spline joint and a universal joint is also claimed to be original when used in conjunction with an electric motor, transmission drive train on a two-wheel vehicle. Even if somewhere in some long past day; someone tried to incorporate the bevel gear, drive shaft, multi-speed transmission, electric motor system; it obviously did not work well enough to become useful or popular. From experiments with previous chain driven prototypes, it is proven that the Electric Horse™ described in this patent application is a useful and soon to be popular tool for rural and urban transportation.

### CROSS-REFERENCE TO RELATED APPLICATION

This is the initial application for this specific invention and the inventor does not claim any benefit of any prior applications relating to this specific invention entitled the Electric Horse™ Battery Powered Electric Motor Bicycle Drive Train.

### STATEMENT REGARDING FEDERAL SPONSORSHIP

My research was in no way federally; state government or commercially sponsored and has been accomplished through my (the inventor's) own personal work and expense.

### BACKGROUND OF THE INVENTION

The field of endeavor leading to this invention is low energy consumption, sustainable, human transportation with a minimum of physical exertion required from the human user. While working in a paper mill as a journeyman electrician, in 1999, I used an electric battery powered saber saw (sawzall™). The power stored in the batteries lead me to realize that recent improvements in battery technology could make it possible for people to travel and commute on electric battery power. Since that initial insight, I built three prototypes. Although an ugly duckling, needing cosmetic and functional refining, the third prototype proved to me that a combination of technologies along with a unique and new mechanical power transfer system, an efficient and functional electric powered two wheel vehicle can be produced and be useful to many people. The following USPTO classifications may relate to the design and function of the battery powered Electric Motor Bicycle Drive Train, named the “Electric Horse™” (a registered trademark in the state of Wisconsin): Bicycle 280/200+, Motorcycle 180, Motorcycle design D12/110, Two Wheel vehicle 180/218+, Electric Motor 180/65.1+, Electric Motor Two Wheeled 180/220, Electric, Motive Power 310, Electric Motive Power Motor and Gearing 310/80, Electric Motor Vehicle 180/65+, Transmission of a Motor Vehicle 180/269, Bevel Gear 74/640.

Briefly; the subject matter of this claimed invention, includes a complete kit or unit able to fit on and motorize a variety of pedal bicycles. The title being a trademark name, Electric Horse™, followed by a string of descriptive words: battery, powered, electric motor, drive train is quite an accurate portrayal of the devise being claimed in its entirety including novel components thereof The drive train as described in this application has enough power to be useful without human pedaling and can be adapted to bicycles without pedals and function as a motorized commuter and recreational vehicle.

It is my belief that the Electric Horse™ original and functional enough to become the first of a whole new class of two wheel vehicles. Many designers and inventors of electric bicycles tend to use cheaply available salvaged parts to attempt to gain function without streamlining to make their bikes look appealing to their possible consumers and end users. This is evident in the many designs I have seen and are collected on the following web site: http://electric-bicycle-experiments.com/page.php?page=2

Another problem with other designs seems to be a miss or lack of understanding concerning the function, properties; power and efficiency RPM bandwidth of electric motors. In other words most of the other designs of electric bikes go with a direct drive one gear ratio design. Others have tried to build the electric motor into the hubs of their wheels, which again is a single speed design http://www.ebiketoday.com/. Still others have tried to build electric motor systems incorporated into the pedal crankshafts of bicycles. These designs do not consider that electric motors run and supply mechanical power efficiently only near their peak freewheeling rpm (1800-10,000 rpm). In other words the debate of the advantages of the Electric Horse™ design as compared to competing designs, it is analogous to one person taking a circular (skill™) saw, butting the blade up to the wood and then turning on the switch then expecting it to cut while the motor is burning up. The other person in this analogy, knowing how to operate the saw turns on the switch and allows the saw to reach it's free spinning maximum speed and then pushes the saw into the wood they want to cut. Continuing the above analogy; the electric motor of the saw, which is butted into the wood, is being forced to produce work starting from a static zero rpm; the motor will be destroyed because it produces heat instead of circular motion. In the case of the electric powered bike, a single speed drive cannot be expected to produce efficient power from a stand still and then accelerate to a reasonable functional speed. The Electric Horse™ improves the efficiency problem by adding a lightweight, multiple speed (gear ratio) transmission to the drive system. While, as with any system of usable machinery invented today, much of the mechanical apparatus is contrived from expired patents which have become public domain (prior art); I claim that the application of such art, along with original aspects described in this application, use make the Electric Horse™ original in design and utility.

There are several problems that exist which have made a practical two wheel electric vehicle beyond reach. One is the available battery technology. It has only been recently that nickel metal hydride and lithium ion batteries have been available to the public. The prices of such batteries are becoming more reasonable and they have a weight to power ratio that is much improved over lead acid, alkaline and other older battery technology. Many other companies such as E-Bike™http://www.ebiketoday.com/, have been incorporating such ‘newer’ batteries into their designs. Another drawback has been the power vs. weight ratio of the electric motors being used. While I do not know exactly what some other manufacturers are using for electric motors, I do know that the rare earth metal(neodymium) D.C. permanent magnet motor I use, supplied by Magmotor™,a Sat Con company, has the necessary power to weight ratio to make an electric bike useful.

The other problem with electric bikes is governmental regulations:
Federal Electric Bicycle Law
HR 727
SECTION 1. CONSUMER PRODUCT SAFETY ACT.
The Consumer Product Safety Act (15 U.S.C. 2051 et seq.) is amended by adding at the end the following: LOW-SPEED ELECTRIC BICYCLES
SEC. 38. (a) Notwithstanding any other provision of law, low-speed electric bicycles are consumer products within the meaning of section 3(a)(1) and shall be subject to the Commission regulations published at section 1500.18(a)(12) and part 1512 of title 16, Code of Federal Regulations. (b) For the purpose of this section, the term ‘low-speed electric bicycle’ means a two- or three-wheeled vehicle with fully operable pedals and an electric motor of less than 750 watts (1 h.p.), whose maximum speed on a paved level surface, when powered solely by such a motor while ridden by an operator who weighs 170 pounds, is less than 20 mph. (c) To further protect the safety of consumers who ride low-speed electric bicycles, the Commission may promulgate new or amended requirements applicable to such vehicles as necessary and appropriate.
(d) This section shall supersede any State law or requirement with respect to low-speed electric bicycles to the extent that such State law or requirement is more stringent than the Federal law or requirements referred to in subsection (a).
SEC. 2. MOTOR VEHICLE SAFETY STANDARDS.
For purposes of motor vehicle safety standards issued and enforced pursuant to chapter 301 of title 49, United States Code, a low-speed electric bicycle (as defined in section 38(b) of the Consumer Product Safety Act) shall not be considered a motor vehicle as defined by section 30102(6) of title 49, United States code.

These Federal regulations, along with certain increasingly stringent state regulations have limited the designers and inventors ambitions, leaving the electric bike as a geriatric, impractical, underpowered piece of oddity (see: http://en.wikipedia.org/wiki/Electric_bicycle_laws). With increased power and responsiveness, the Electric Horse™ will bypasses such over regulation by making it useful and available to all terrain and outdoor rural sport enthusiasts. Off road vehicles are less regulated, and the near silent stealthy operation give the Electric Horse™ advantages over loud, internal combustion ATVs for use by hunters, wild life watchers and nature seekers.

So besides being an improved electric bike design, the Electric Horse™ a totally new class of vehicle, a ‘two wheel all terrain electric vehicle’. There is a video clip of my third prototype available for viewing at: http://www.current.tv/watch/3369995. Also the specifications of the Curtis™ Controller which will be used on the Electric Horse™ as described in this patent application can be programmed to limit its power and speed to meet most federal and state regulations for on the road use.

### BRIEF SUMMARY OF THE INVENTION

The object of this invention is to supply battery electro/mechanical power to a lightweight two-wheel vehicle efficiently. The design also allows for hybrid combination human and electrical powered transportation. Above and beyond this, the Electric Horse™ installed on a bicycle, could also be placed on a stand and used to generate power in cases of electrical outage or in back country rural wilderness settings. This is all accomplished through: 1.) The use of a bevel gear mounted to conventional ISO standard disk/caliper break rotor mount. A variation of the bevel gear design gear will also be produced and available to fit the Shimano style break rotor/hub mount. 2.) a housing which holds the pinion gear to its mating position with the bevel gear and secures it to the frame. 3.) a shaft that connects the pinion to the transmission. 4.) A gear type transmission(s) with 4, 6 or 8 gears. 5.) an electromechanical shifting mechanism. 5.) batteries mounted within vacant areas of the bicycle frame. 6.) a combination controller/charger/battery case luggage rack 7.) The Electric Horse™ can be adapted and mounted to virtually any adult size pedal bicycle. 8.) The design utilizes a computerized permanent magnet motor controller, an electric stepper motor transmission shifting mechanism coupled with a two push button electrical shifter switch and a twist grip 0-5V potentiometer throttle for operation by the rider.

### BRIEF DESCRIPTION OF THE SEVERAL VIEWS OF THE DRAWING

FIG. 1: is a drawing of the entire unit retrofitted to a bicycle.

FIG. 2: is a closer view of the mechanical drive train components.

FIG. 3: detail of the bevel and pinion gear assembly and pinion housing.

FIG. 4: is a drawing of bicycle disk break rotor mounting patterns.

FIG. 5: is a side view detail of the transmission.

FIG. 6: is a frontal view of the transmission.

FIG. 7: the human generation station stand.

FIG. 8: a copy of the certificate claiming the trademark “Electric Horse” in the State of Wisconsin

### DRAWINGS INDEX:

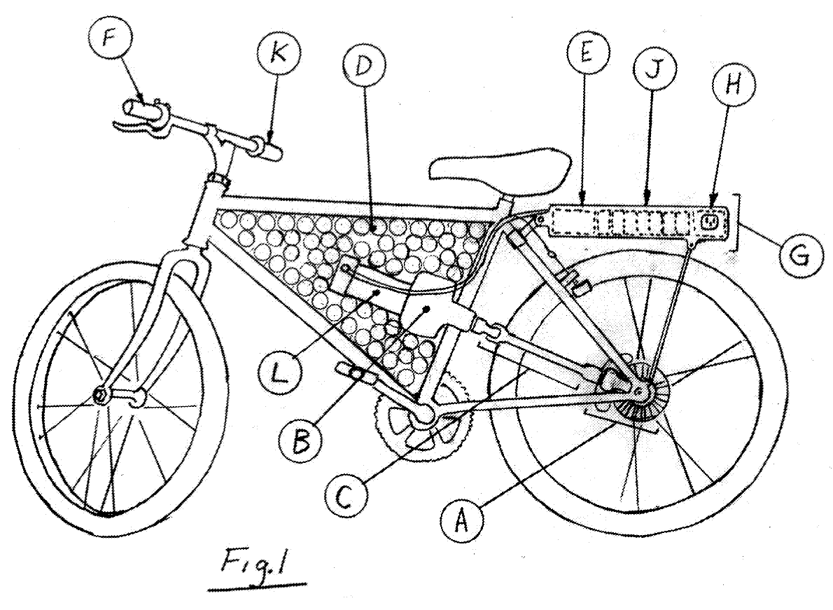

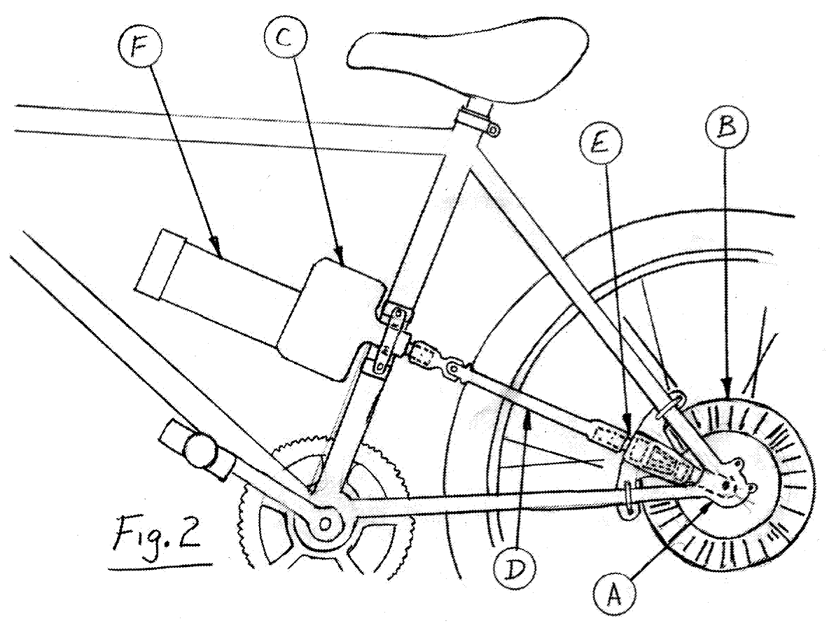

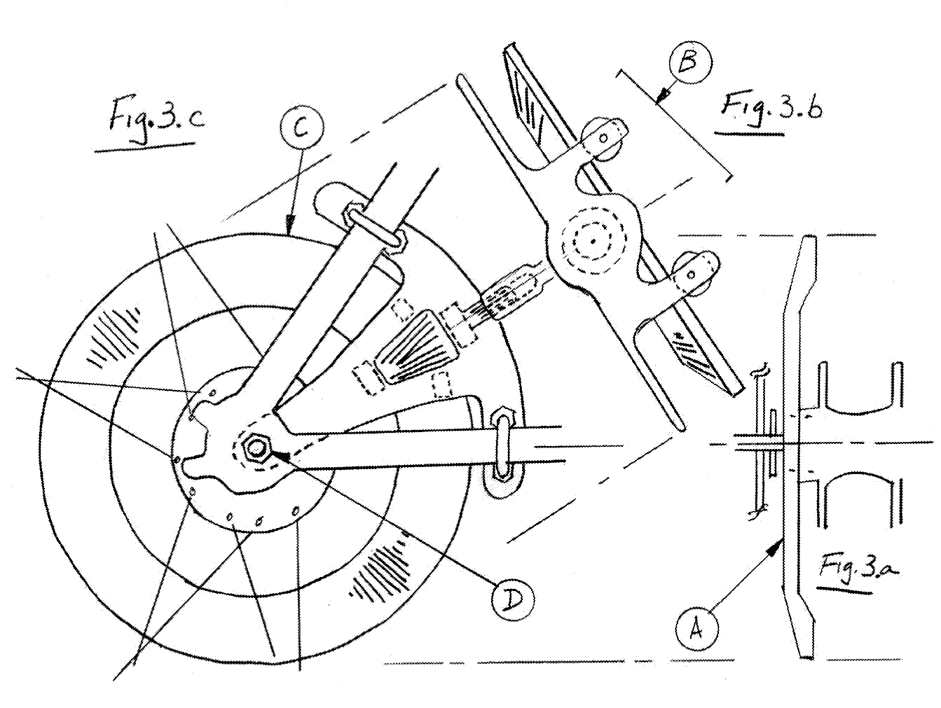

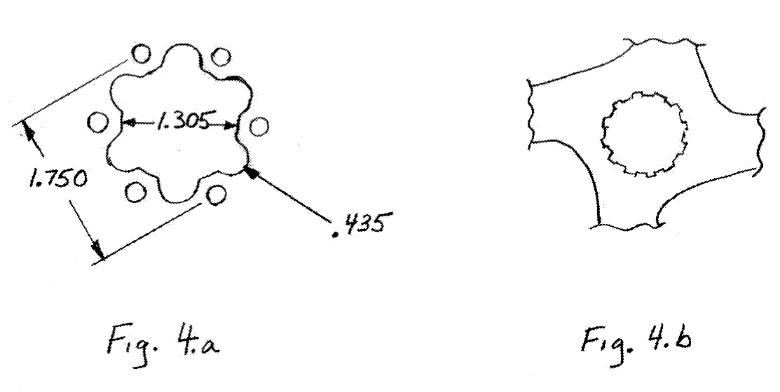

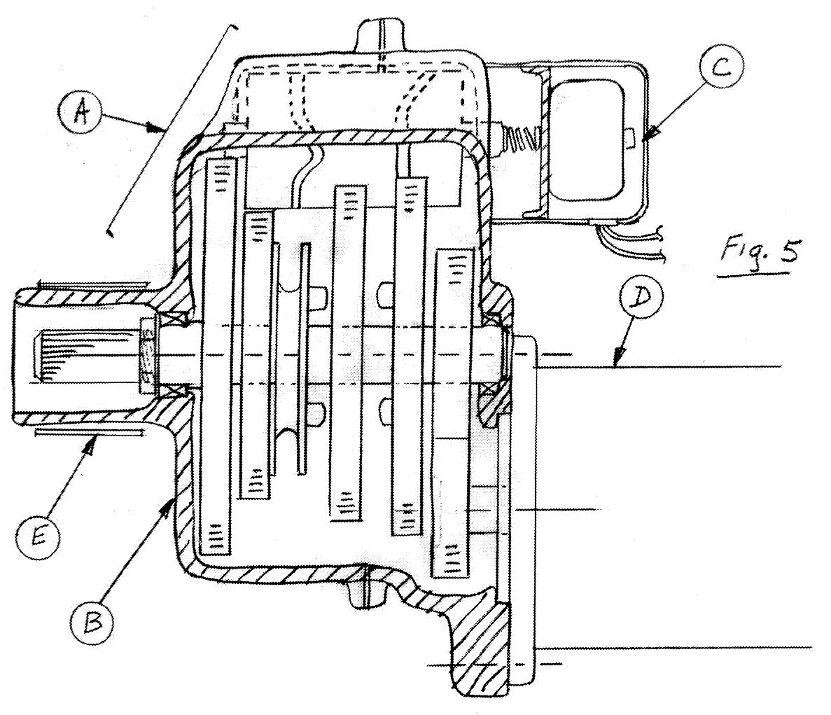

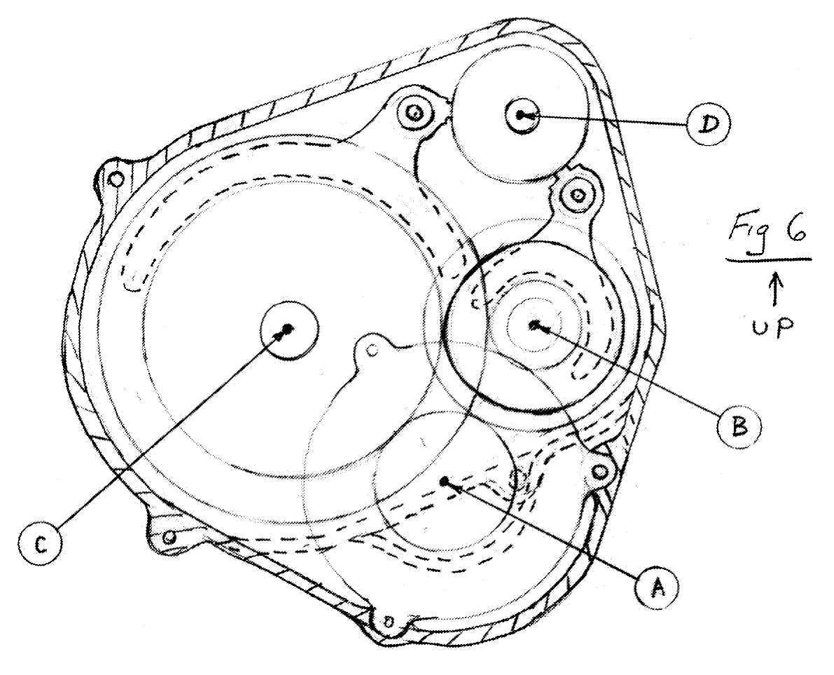

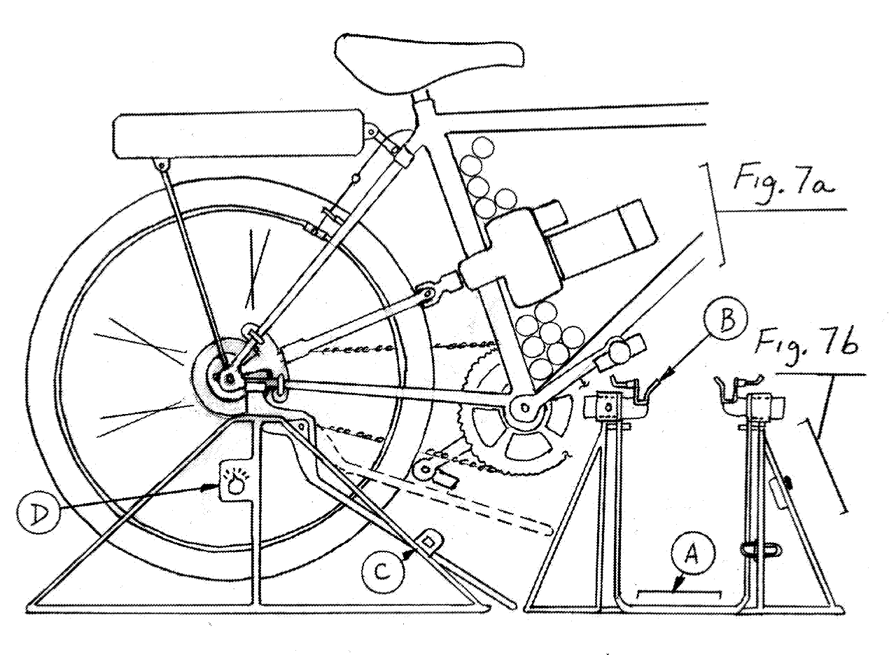

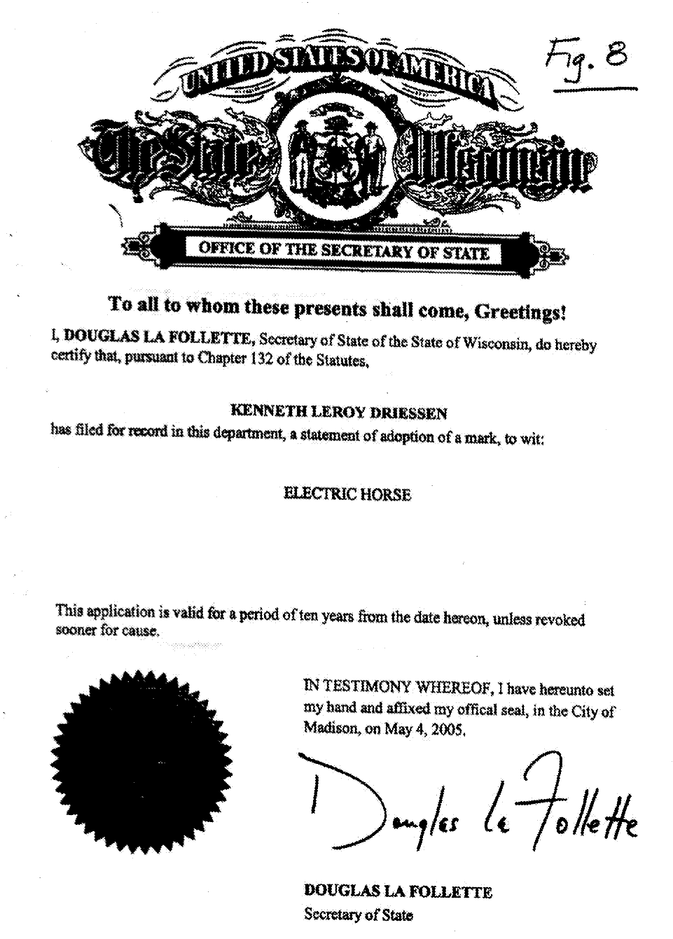

FIG. 1=page 12, FIG. 2=page 13, FIG. 3=page 14, FIG. 4=page 15 FIG. 5=page 16, FIG. 6=page 17, FIG. 7=page 18, FIG. 8=page 19

### DETAILED DESCRIPTION OF THE INVENTION

Making (manufacturing) of the Electric Horse™ Invention: The first model to be produced in quantity, will be manufactured through use of subcontractors and vendors where custom parts will be produced in batches and stock parts will be purchased as needed then these parts will be assembled to produce the kits (units). Some of the units will be mounted onto bicycles (generic, average, hard tail mountain bicycles). The design drawings, of the transmission here submitted are the actual size of the first model to be released. This size is chosen to incorporate preexisting gasoline powered motorcycle transmission parts. When large-scale custom production is financially possible, the transmission will be drawn up to adapt current input and output devices, with internal and housing components built on a ⅔ scale, compared to the drawings submitted. The design I claim (in full and approximately ⅔ scales), will require casting a custom gearbox case to hold stock or custom gears which will become the transmission of the drive train. It will be explained in the claims section of this application that: the gear ratios are believed to be novel and crucial to the workings and efficiency of the design and utilization of the Electric Horse™. I will also produce six and eight speed transmissions on the same smaller scale with gear ratios provided in this application directly below:

Gear Ratios:

Bevel: pinion 2:1<4:1<6:1 (two to one or greater and less than six to one)

Trans' input : Electric motor output 1.5:1 (greater than one to one and less than four to one)

Transmission speeds (gear ratios)

| | 4 speed | 6 speed | 8 speed |
|---|---|---|---|
| 1 | 4.3:1 | 4.7:1 | 4.7:1 |
| 2 | 3:1 | 3.5:1 | 3.5:1 |
| 3 | 2.2:1 | 2.7:1 | 2.6:1 |
| 4 | 1.5:1 | 2:1 | 1.9:1 |
| 5 | — | 1.5:1 | 1.46:1 |
| 6 | — | 1:1 | 1.06:1 |
| 7 | — | — | .98:1 |
| 8 | — | — | .93:1 |

Concerning the actual manufacturing of the Electric Horse™, the bevel and pinion housing can be cast or fabricated from iron, steel, magnesium or aluminum and may even be made of plastic. The transmission housing can also be cast from the same variety of materials through normal well known casting processes. The bearings and some of the gears will be stock parts available from a variety of vendors. Some of the gears will be purchased and then the mountings, such as to the rear hub to bevel gear, will be custom machined by normal, standard, accepted machining practices. In fact everything necessary to cast fabricate and assemble the Electric Horse™ can be accomplished using well known manufacturing methods and no claims are made in this application regarding the methods of producing this devise, it is just the workings and design of the devise which is claimed to be utility patent able.

1. The entire Electric Horse™ battery powered, electric motor bicycle drive train, as a whole is claimed as an invention with rights to be granted as documented with this application. This Inventor/Applicant is prepared to amend, redraw, rewrite, add to, hoop jump and do what ever the USPTO officers deem necessary to insure that this invention, which came to this inventor through his own honest thought and hard work, is protected copiers and infringements in it's entirety and in every individual detail and sub claim, which are dependant upon one another in order for the invention to achieve, operate and/or perform the function(s) described within this application. It is claimed here within this application that no one before the date of this application has patented a devise combining and utilizing the following mechanical components being: bevel pinion gear set, shaft driven, transmission regulated, rare earth magnet motor driven, battery powered, computer controlled, regenerative breaking, unit able to propel a bicycle with or without human pedaling assistance in any size shape or form. When the unit is mounted on a bicycle and the bicycle is placed on a stand, it can also be pedaled to generate emergency and recreational rural electricity. This Applicant has searched USPTO patents archives, Internet sources and libraries to attempt to find a previously designed devise capable of achieving a similar function through the use of similar mechanical and electrical devices. This applicant found no patent or device of sufficient similarity to prevent him from applying for this patent. This Patent Applicant believes that anybody that puts up for sale a bicycle with a drive train including the following: a bevel gear, shaft drive, multiple gear transmission, electric motor driven, battery powered two wheel vehicle is copying and infringing on this inventors patent rights as of the day this application has been filed. Listed below are sub claims, which are said to be original and patent able components invented as necessary parts of the whole invention entitled the Electric Horse™. The components claimed and described below are what the Electric Horse™ actually consists of and the above said invention's functionality is dependant on these novel and original components. This Applicant/Inventor claims that the use of even one component of sufficient similarity to the components described and claimed below, to achieve a similar function, without a license or permission of use granted by this applicant, will be an infringement of this applicants rights:
(a.) The adaptation and mounting of, a bevel gear to the ISO and/or Shimano disk break system rotor mounts is claimed as an original concept illustrated in FIG. 3(A) and FIGS. 4 (A) & (B). To utilize the standard mounting pattern; previously and normally used to mount a rotor disk of a bicycle breaking system where a caliper is used to cause friction on the rotor to slow (break) the speed of the bike; installing a mechanism to said mounting system illustrated with the FIG. 4 drawing attached to this application, to incorporate electric power to propel the two wheel vehicle is claimed original in construction, operation and design.
(b.) The drawing titled FIG. 3(FIG. 3 A thru D) illustrates a method/methods used to mate the pinion gear to the bevel gear and attach the gear set to the bicycle by mounting the pinion gear within a rigid, cast or fabricated housing. The housing is attached to the bicycle rear wheel frame arms through the use of ‘U’ clamps and slotted holes in the housing pictured in FIG. 3(b) and 3(b). The said housing will also be connected to the hub shaft by attaching the ear of the housing (FIG. 3(A)) to the stock, prior art, shaft in a place that is normally occupied by a spacer which is sandwiched between two retaining nuts. This housing pictured in FIGS. 1(A), 2(E) and 3 (A),(B) & (D) is universal, meaning it can be installed on a variety of bikes is claimed as an original design and function.
(c.) The use of a drive shaft with a sliding spline and a universal joint to transfer power to the (on opposite side of the sprocket and derailleur used for manual pedaling) rear wheel of a bicycle from a transmission and electric motor is claimed as a necessary component of the Electric Horse™. The shaft is said to be a solid shaft between ¼″ and ⅝″, and/or a hollow shaft between and ⅜″ and 1 ½″ and made of any combination of steel, aluminum, plastic, fiberglass or composite material including and limited to such a shaft when used to transfer power in the form or rotational motion from an electric motor and/or electric motor transmission combination to the rear wheel of a bicycle is claimed to be original in design and utilization. The shaft and it's placement and use are illustrated in FIGS. 1(C) and as FIG. 2(D).
(d.) A wide gear range semi automatic transmission with an electric drive motor attached directly through a set of gears and a splined output shaft made to match the drive shaft. The size of the transmission is claimed to be as large as a 1:1 scale of FIG. 5 of the side view illustration and 1:1 scale of FIG. 6 the frontal view drawing of the said transmission. It is claimed that a transmission with similar range of gear ratios and as small as ½ the size of the FIGS. 5 & 6 drawings is large enough and strong enough to function and perform as described in this Application. In other words if entity were to build and sell a transmission to be used on an electric powered bicycle with gear sets and ratios within the limits described under the heading “gear ratios” below page 6 of this application, at any scale between the actual size of the drawings provided or a similar transmission within the ratios described scaled down to as small as ⅓ the size of the FIGS. 5&6 drawings, they would be infringing on this Inventor's rights if they did not gain a license or permission from this Inventor.
Transmission speeds (gear ratios)

| | 4 speed | 6 speed | 8 speed |
|---|---|---|---|
| 2 | 4.3:1 | 4.7:1 | 4.7:1 |
| 2 | 3:1 | 3.5:1 | 3.5:1 |
| 3 | 2.2:1 | 2.7:1 | 2.6:1 |
| 4 | 1.5:1 | 2:1 | 1.9:1 |
| 5 | — | 1.5:1 | 1.46:1 |
| 8 | — | 1:1 | 1.06:1 |
| 9 | — | — | .98:1 |
| 8 | — | — | .93:1 |

(e.) A stepper motor gear shifting mechanism controlled by a PLC connected two electrical buttons on the handle bar grip. A stepper motor which can be programmed to move a certain amount of steps in either direction will be attached to the end of the gear selector indexing drum to rotate the drum which controls the position of forks that slide the gears in and out of position, see FIGS. 5(G) and 6(D).
(f.) Modifications to the motor controller to improve the operation of the controller when it is adapted to the use as specified and claimed in this application. The transistors and microcircuits of silicon chips within a/the direct current permanent magnet motor controller as modified, is redesigned and programmed to separate the throttle and regenerative breaking functions to allow for coasting and separate the throttle and breaking functions so they can be operated from two separate external control switches. A breaking lever is placed on the left handlebar which will control a potentiometer allowing a variable signal to be sent to the controller which in turn will vary the amount of resistance to motion the drive motor will produce when it is transformed into a breaking motor electronically by the controller. The break lever will also signal the controller to deactivate any reading from the twist throttle potentiometer when the break is engaged even minutely.
(g.) The separate regenerative breaking potentiometer effect of the above modified controller is adaptable to a rotating dial on the bike stand which is an Electric Horse™ accessory, so emergency power can be generated by human pedal power input. The break lever that is used to slow and stop the bike when it is used as a travel vehicle can be disconnected when the bike is attached to a stand that lifts the rear wheel of the ground. The dial potentiometer is not spring controlled and stays in what ever position it is set at to vary and set the resistance and human strength required to use the motor of the system as a generator. When on the stand a bicycle fitted with the Electric Horse™ can be used to recharge its own batteries or to supply power residential 120 VAC electric power through an optional inverter installed on the bicycle stand.
(h.) A battery/equipment compartment/luggage rack combination including motor controller and battery charger. It is claimed that the molded plastic case, that functions as a luggage rack and equipment enclosure is an original design. It is claimed that these functions have never been combined for use on an electric motor powered bike, which has been patented prior to this application. If indeed a similar device which combines all the features described above and in FIGS. 1: (G), (E), (J), and (H); let it be known that it is in this case it is claimed that the length, width, height of the luggage rack, and the size, shape and functionality of the said equipment within the luggage rack do vary from any other known design to the degree where this design does not infringe on the rights of any similar patented devise.
(i.) A Battery mounting scheme where the individual D or F size batteries are arranged horizontally in vacancies in the frame, around the motor and transmission, connected in a multiple 20 battery series/parallel configuration as illustrated in FIG. 1 is claimed to be original and patent able.
(j.) The human electric generation station stand, pictured in FIG. 7 is claimed to be a novel design. There will be a one-time locking adjustment process to match the stand to the bike. There is a foot lever to lift the bike off the ground where it is locked in place by a spring operated latch that has a finger pull lever to release the lock when the operator wants to take the bike off the stand. There is a potentiometer on the stand that hooks into the controller parallel to the break lever on the bicycle's handle bars. When the bike is used in this manner the break is already off and the potentiometer on the stand will take over.
